(19) United States
(12) Patent Application Publication
(10) Pub. No.: US 2006/0088178 A1
(43) Pub. Date: Apr. 27, 2006

(54) Ear flaps for helmets

(76) Inventor: Garth Wayne Whelen, Calgary (CA)

Correspondence Address: Garth W Whelen, 50 Cramond Close SE, Calgary, AB, T3M1C1, CA

(21) Appl. No.: 10/509,489

(22) PCT Filed: Nov. 27, 2002
(86) PCT No.: PCT/CA02/01817

§ 371 Date: Sep. 29, 2004

(30) Foreign Application Priority Data
Mar. 5, 2002 (CA) 2,376,047

(51) Int. Cl. H04R 5/02

(52) U.S. Cl. 381/301

(57) ABSTRACT

Eear flap/warmers (1) found in sporting helmets (2) allow the wearer to connect to and utilize external audio (stereo) reproduction and/or 2-way communication devices with added convenience over previous inventions by incorporating a mechanical electrical interconnect (12) located in or by replacing, the helmet chinstrap connection. The user can conveniently don or remove said EAR FLAPS (1) equipped helmet by disconnecting and reconnecting said interconnect. Added convenience to EAR FLAPS (1) can be provided by use of multifunctional chinstrap connection mechanical electrical interconnects (12) providing the benefits of the electrical interconnect (12) with the functioning to secure the sporting helmet (2) chinstraps (10). Where applicable said multifunctional chinstrap connection can also incorporate a built in microphone and (where applicable and not installed in said ear flap/warmers) circuitry, resistors and/or switches to allow the function of audio reproduction and 2-way communication through the same EAR FLAPS (1) equipped helmet (2).

### TECHNICAL FIELD

BUCKET FLAPS combines technologies of head-protective equipment, namely sporting helmets, and an audio (stereo) reproduction, and/or 2-way communication system. BUCKET FLAPS consists of sporting helmets with electrical audio equipment incorporated therein for connection to, and use of, audio (stereo) reproduction and/or 2-way communication devices. BUCKET FLAPS is designed for use by sporting enthusiasts, athletes, coaches, or by other personnel wherein the user desires the convenient use of said audio devices while donning said head-protective equipment.

### BACKGROUND ART

BUCKET FLAPS allows the user to comfortably listen to music, or communicate on two (2) way communication systems, while wearing a sports helmet by eliminating headbands and in-ear style speaker systems. Safety concerns with headphone use while engaging in sports are reduced by enforcing helmet use, separating the speaker from the ear allowing for outside noises/sounds to enter and preventing wire snags by confining the wires along the existing helmet chin strap. Convenience is increased with a mechanical electrical connection at the chinstrap buckle for putting on and removing the helmet by separating the wire connection at said buckle, which may or may not also include a built-in microphone for two (2)-way communication. BUCKET FLAPS audio support helmets with the chinstrap mechanical electrical connection is an improvement over other similar prior art such as the following (listed by U.S. Patent File Number): U.S. Pat. Nos. 5,404,577 5,678,205 6,104,816 4,833,726 6,157,298 6,101,256 6,298,249 5,625,903 5,600,730 5,953,434 4,130,803 4,7761,044 D378,158

### DISCLOSURE OF INVENTION

The following information describes the invention entitled BUCKET FLAPS. Please refer to the following FIG. 1 through FIG. 5 with references to specific parts indicated by the numeral in the brackets following the part identification and corresponding to the numbers shown in said figures.

BUCKET FLAPS (1) are ear flap/warmers found on sporting helmets (2), that may or may not be removable by temporary attachments (i.e. Zipper, Velcro, Snap) (17), consisting of two speakers (3) mounted inside two ear flaps/warmers (1) where the speakers may be mounted in a manor to prevent movement or damage due to shock or environment (i.e. mounting plates or layers (4)) that are then joined to the inside of the ear flap/warmers (1) in such a way as to allow the sound to pass freely through the first inner layer(s) of the ear flap (5), mounting plate or layer (4) while being protected by the last outer layer(s) (6). The speakers contain the necessary terminals (7) for the connection of the audio (speaker) connection wires (8). The speaker connection wires (8) extend through a hole (9) from the ear flap/warmers (1) to the chinstrap location. The connection wires (8) join at a mechanical electrical connection (12) or at the helmet chinstrap connection (13). The mechanical electrical connection (12) allows the unobstructed removal of the helmet by allowing the mechanical separation of the two, speaker connection wires (8) connecting one side of the speaker systems to the remaining system components by mechanically opening/closing the circuit and physically separating the connection wires. At the chinstrap mechanical electrical connection (12) the two, speaker connection wires (8) connect to a common connection wire (14) terminating at a stereo headphone connector plug (15) that connects to a personal audio player. The 2-way model BUCKET FLAPS includes the placement of a microphone to be in the chinstrap mechanical electrical connection terminal (12). The remaining connections are consistent with the stereo model terminating at a connection plug (15).

BUCKET FLAPS mechanical electrical connection, with or without the additional microphone for two 2-way communication applications (13) may incorporate the additional function of providing the mechanical connection of securing the helmet to the user by providing the required mechanical connection of the two separate chit-straps in a single combined unit where electrically conductive contact points are installed in the receiving end (13r) and the plug end (13) of said chinstrap clip and said contact points are connected to said speaker connection wires (8) connected to a common connection wire (14) with functioning to fasten the helmet chinstraps (10) and providing a closed, electrical circuit when the clip is engaged,

A two 2-way Model Chinstrap Connector (13 2-way: FIG. 5) incorporates all said features of the stereo (FIG. 4) model with the addition of a microphone encased in the receive end (13r), or plug end of said clip in a manner permitting the travel of sound vibrations through the casing while prohibiting the entrance of moisture with all necessary electrical connections to provide a closed electrical circuit when the clip is engaged.

BUCKET FLAPS ear flaps/warmers may also contain electrical switching and additional circuitry as needed to, adjust audio system volume by the addition of a variable resistor electrically connected to the connection wires, switch the electrical circuit path between the stereo audio connections and the two 2-way communication path or open or close any of said electrical paths.

### DESCRIPTION OF DRAWINGS

FIG. 1 Major Components View (Attached)

Shows the general placement of major components as in use as attached to a Sporting Helmet,

FIG. 2 Major Components View

Shows the surface view of the major components without the helmet attached.

FIG. 3 Ear Flap/Warmer Cutout (Rear) View

Shows a cutout schematic of the Ear Flap/Warmer to illustrate the placement of the speaker system.

FIG. 4 Chinstrap Connector

Shows an example of a mechanical electrical interconnect that simultaneously functions to conduct an electrical signal and secure helmet chinstraps.

FIG. 5 Chinstrap Connector Receiver 2-way Model

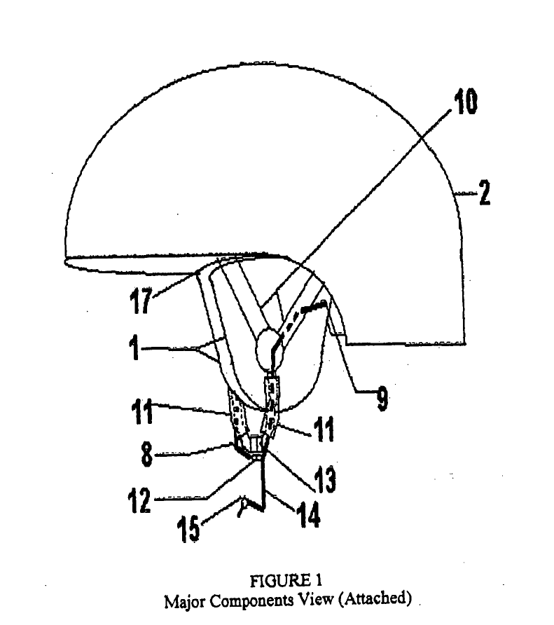

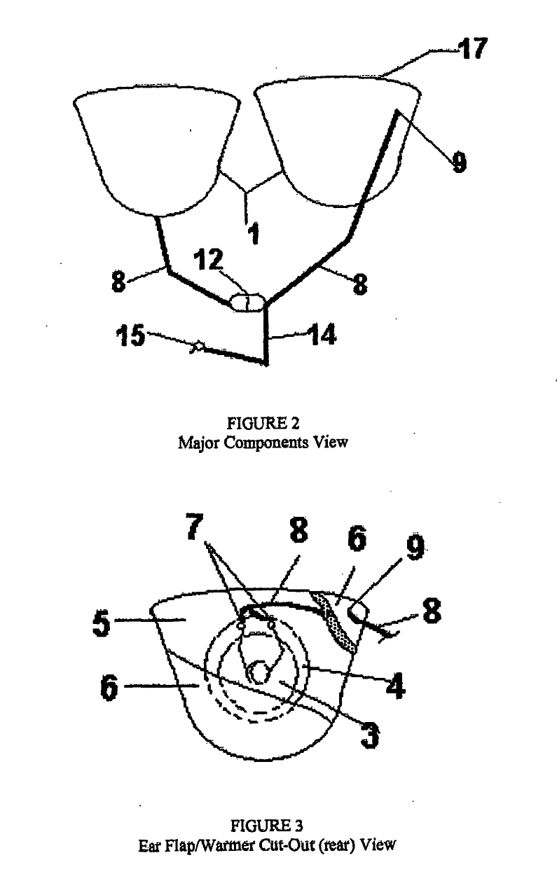

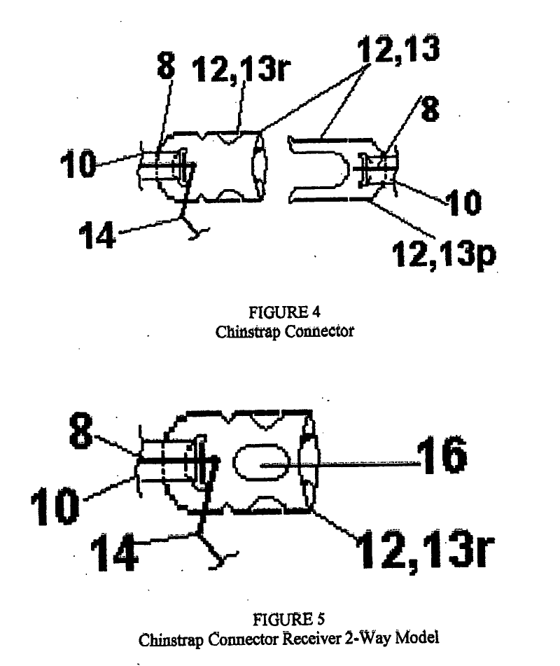

Shows an example of the multifuctional chinstrap connector receiver section of FIG. 4 complete with a built in microphone.

### BEST MODE FOR CARRYING OUT INVENTION

BUCKET FLAPS equipped sporting helmets will ideally incorporate the dual functionality of providing audio (stereo) reproduction and 2-way communication with a multifunctional chinstrap connection mechanical electrical interconnect that allows separation of the connection wires between the left and right speakers, securing the helmet chinstraps and incorporating a microphone therein, with a switching device allowing the wearer to switch between the two functions of the invention located in the permanently connected earflap. The speakers would be mounted behind a layer of fleece fabric, providing protection between said speaker and the users ears. The speakers would be set inside a neoprene rubber layer which would also include the necessary mounting hardware securing the earflap to the helmet, providing a permanent setting for the speaker and switch location within said earflap. The earflaps should then be backed with a second neoprene layer attached by contact cement to the first, providing protection for the speaker from the elements and acting as an acoustic baffle for said speaker. Finally a second, thick or doubled over fleece layer would be hot-stitched (so as to provide/maintain adequate air seal) over the exposed edges providing an additional barrier for wind and cold for the user.

1. The use of Ear Flap/Warmers in sporting helmets, permanently or temporarily affixed, with two (2) internally mounted (stereo) speakers, one in each ear flap/warmer secured in a manor preventing the speaker to move or shift within the ear flap/warmer, or become damaged due to environment, connected to an external audio signal source through connection wires with a mechanical electrical interconnect between the two sides of the ear flap/warmers allowing for the separation of said connection wires at the location of the helmet chinstrap connection.

2. Ear Flap/Warmers as described in claim 1 (above) with the mechanical electrical interconnect as described in claim 1 designed in such a way as to also function as the mechanical connection device securing the chinstraps of said sporting helmet.

3. The mechanical electrical interconnect as described in claim 1, with the additional function of securing the sporting helmet chinstaps as described in claim 2, with the additional function of a microphone mounted within said mechanical electrical interconnect so as to provide sound reception for use with an external 2-way communication device whereby one or more of the speakers described in claim 1 shall function as an audio output source for said 2-way communication device and where both ear flap/warmers and mechanical electrical interconnect contain wiring connections to provide connection to said external device.

4. The mechanical electrical interconnect as described in claim 1, without the additional function of securing the sporting helmet chinstraps as described in claim 2, with the additional function of a microphone mounted within said mechanical electrical interconnect so as to provide sound reception for use with an external 2-way communication device whereby one or more of the speakers described in claim 1 shall function as an audio output source for said 2-way communication device and where both ear flap/warmers and mechanical electrical interconnect contain wiring connections to provide connection to said external device.

5. Ear flap/warmers as described in claim 1, with the multifunctional microphone inclusive mechanical electrical interconnect described in claim 3 or claim 4, incorporating an electrical or mechanical switching device, or additional circuit, allowing said Sporting Helmet to be used both as a (stereo) audio reproduction device and 2-way communication device by switching the functions of the speakers and microphone between the functional connections to the external audio and 2-way communication sources by opening and closing the electrical circuit pathways between said speaker and microphone components and wiring connections.

6. Ear flap/warmers as described in claim 1 with the additional 2-way communication function described in claim 3 or claim 4 incorporating the dual functionality of audio (stereo) reproduction and 2-way communication through connection to an external source capable of providing the functions of both audio (stereo) reproduction and 2-way communication, where the external multifunctional source contains an electrical or mechanical switching device, or additional circuitry, to switch between the dual functions of audio (stereo) reproduction and 2-way communication, and is connected to said external device through one or more electrical connections.

7. Ear flap/warmers as described in claim 1, with or without the multifunctional chinstrap connections described in claim 2, claim 3 or claim 4 with or without the dual function capabilities described in claim 5 or claim 6, with the addition of a resistor, of specific or variable resistance, located along the said electrical connections to provide resistance for the purpose of limiting the volume of the said speakers and/or microphone.
